(19) United States
(12) Patent Application Publication
(10) Pub. No.: US 2024/0028012 A1
(43) Pub. Date: Jan. 25, 2024

(54) PRODUCTION SYSTEM AND METHOD FOR OPERATING A PRODUCTION SYSTEM

(71) Applicant: HOMAG GmbH, Schopfloch (DE)

(72) Inventors: Patrick MÜLLER, Glatten (DE); Philipp HENRY, Ofterdingen (DE); Jochen PAUL, Eggstätt (DE)

(21) Appl. No.: 18/023,669

(22) PCT Filed: Aug. 26, 2021
(86) PCT No.: PCT/EP2021/073624

§ 371 Date: Feb. 27, 2023

(30) Foreign Application Priority Data
Aug. 27, 2020 (DE) 10 2020 122 403.6

(51) Int. Cl. G05B 19/418

(52) U.S. Cl. CPC G05B 19/41855; G05B 2219/31348; G05B 2219/32128; G05B 2219/45229

(57) ABSTRACT

A production system that includes a device for processing, handling or storing workpieces made of wood, wood materials or plastic, or for handling or storing mounting material, equipment or tools. The system can also include a detection module for detecting at least one measurement parameter and a multifunctional gateway unit. The multifunctional gateway unit can have a communication server that operates in accordance with a predetermined communication standard and is configured to compare the communication standards of the communication server and of a communication client.

### TECHNICAL FIELD

The invention relates to a production system comprising a device which is used in particular for processing, handling or storing workpieces preferably consisting at least in parts of wood, wood materials or plastic, or which is used in particular for handling or storing mounting material, equipment or tools, and to a method for operating a production system.

### PRIOR ART

In recent years, production systems for processing, handling or storing workpieces have become subject to ever-increasing interconnection. For example, machines and facilities are internally interconnected with one another in terms of data, and in addition more and more machines and facilities are coupled to external devices via the Internet. The term “Industry 4.0” has become established for this.

A system which allows communication with a woodworking machine via a remote data transmission interface is disclosed in DE 10 2017 207 993 A, for example.

In order to be able to interconnect the respective machines and facilities with other devices or provide them with additional functions, an individual, tailored solution is usually required, which leads to a high technical effort.

### DESCRIPTION OF THE INVENTION

It is an object of the invention to allow, quickly and with little effort, interconnection and functional enhancement of a device which is used in particular for processing, handling or storing workpieces, mounting material, equipment or tools.

According to the invention, this object is achieved by a production system according to claim 1 as well as a method for operating a production system according to claim 12. Particularly preferred further developments of the invention are specified in the dependent claims.

The invention is based on the idea of allowing interconnection and functional enhancement of a device without requiring an operator to perform complicated interventions or inputs. For this purpose, the production system according to the invention comprises, on the one hand, a detection module for detecting at least one measurement parameter and, on the other hand, a multifunctional gateway unit, each having the properties defined in more detail in claim 1. In this respect, the detection module comprises a communication client which operates in accordance with a predetermined communication standard, and the multifunctional gateway unit comprises a communication server which operates in accordance with the predetermined communication standard and is designed to check whether the communication standards of the communication server and of the communication client are identical and, if they are identical, to couple the multifunctional gateway unit to the detection module via the communication interfaces.

This makes it possible to flexibly and simply expand the production system with additional functions at any time by integrating a suitable detection module into the production system via the gateway unit as required. In this respect, the specific design of the detection module with the communication client and of the gateway unit with the communication server ensures that the at least one detection module can be integrated with little effort and, under certain circumstances, even automatically. In any case, complicated user interventions or inputs can be avoided or minimized.

The communication standards of the communication client and of the communication server can be selected from a plurality of standards within the scope of the invention. According to a further development of the invention, however, it is provided that at least one communication standard is selected from MQTT, CuAP, DDS, XMPP and OPC-UA. These communication standards are characterized by low energy consumption and a sufficient data transmission rate as well as simple and quick coupling.

The preferably wireless interfaces of the multifunctional gateway unit and of the detection module can also be designed in many ways, but are preferably selected from WLAN, Bluetooth, Zigbee, ZWave, Enocean and Endiio. The simplicity of coupling on the one hand as well as the low energy consumption and the sufficient data rate on the other hand also play an essential advantageous role for these interfaces.

According to a further development of the invention, it is also provided that the production system comprises a configuration module which is designed to allow the input of a condition for a detection result of the detection module and the input of an instruction to be output to at least one external unit when the condition is fulfilled. In this way, not only coupling of a detection module can be effected in the production system according to the invention, but certain functions of the detection module can also be configured in a simple and direct manner.

As regards the configurable functions, there are practically no limits within the scope of the invention, with numerous examples being given for this purpose in the description of preferred embodiments below.

With regard to the simplest and quickest operability possible, it is provided, according to a further development of the invention, that the configuration module provides a graphical user interface where at least one object selected from the detection module, the type of condition, the content of the condition, the type of instruction, the content of the instruction and the external unit can be selected graphically. Thus, the configuration of the production system according to the invention is further drastically simplified since an operator does not have to perform any complicated programming, but only or predominantly has to make graphical inputs in order to set up a particular detection module.

In this respect, it is particularly preferred that the configuration module allows the configuration of a detection module by graphical input and/or input of parameter values without requiring further inputs. Thus, the configuration cannot only be performed simply and quickly, but it can usually also be performed by the person who generally supervises the machine, so that a programmer or IT specialist, for example, is not required.

According to a further development of the invention, it is provided that the production system comprises an output module which is designed to monitor the values detected by means of the detection module and, depending on the configuration of the detection module, to output an instruction to the unit defined in the configuration. In this way, the production system can be freely interconnected with any external units, also functionally, so that events within the production system cause the desired effect on and instruction to an external unit. This results in an extreme functional enhancement, the range of which is explained in more detail in the description of preferred embodiments below.

The detection module can also be designed in many ways within the scope of the invention. According to a further development of the invention, however, it is provided that the detection module is selected from a camera, a microphone, a light sensor, a temperature sensor, a motion sensor, a vibration sensor, a tactile sensing device, a switch, a rocker and combinations thereof. This results in an extremely wide range of functional enhancements of the production system, with each of the aforementioned embodiments having its specific advantages.

According to a further development of the invention, the at least one external unit is selected from a local or non-local data server, a mobile terminal, a manual pointer, lighting, a speaker, an actuator and combinations thereof. The invention thus allows an extensive connection of an almost infinite number of functions, with the functions also being able to be executed or initiated in a spatially separated manner, in particular when a data server is used.

According to a further development of the invention, at least one detection module and at least one external unit are integrated at least in parts. This does not only result in a simplified design of the production system according to the invention, but also allows further simplification of the configuration of the system. An advantageous example of such an integration of detection module and external unit is a so-called smart speaker, although various other designs are also possible.

In addition, according to a further development of the invention, it is provided that the production system comprises a mobile terminal which is designed to communicate with the multifunctional gateway unit in particular via a data server, preferably with the configuration module and/or the output module. Thus, on the one hand, the design of the production system according to the invention can be kept simple since the multifunctional gateway unit and the detection module do not require a separate input and display device. In addition, the flexibility of the production system according to the invention is also increased since the respective operator may participate in the production system with his “own” mobile terminal and, in doing so, can resort to individual settings without always having to input them again. Moreover, the mobile terminal can contribute to simplifying the configuration of the at least one detection module or the forwarding of instructions to the at least one external unit.

The above advantages are particularly apparent in a method for operating a production system according to claims 12 to 15.

### BRIEF DESCRIPTION OF THE DRAWINGS

FIG. 1 schematically shows an embodiment of a production system according to the invention;

FIG. 2 schematically shows a graphical user interface of the production system according to FIG. 1.

### DETAILED DESCRIPTION OF PREFERRED EMBODIMENTS

Preferred embodiments of the invention are described in detail below with reference to the accompanying drawing.

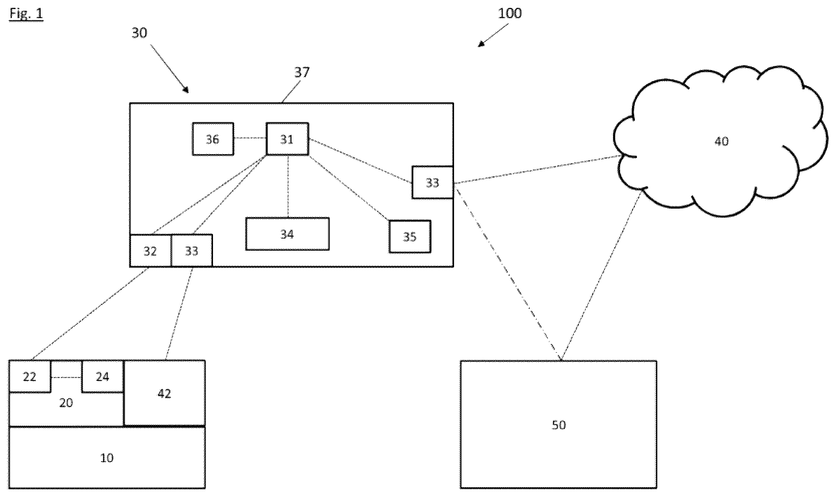

A production system 100 according to a preferred embodiment of the invention is schematically shown in FIG. 1. The production system is used for processing, handling (for example relocating or transporting) or storing a wide range of objects and comprises, for this purpose, at least one device 10. The objects can be, for example, workpieces, but also, for example, tools, consumables, equipment or the like. In the present embodiment, the device 10 is designed for processing, handling and storing workpieces consisting at least in parts of wood, wood materials, plastic or the like, as are widely used in the furniture and components industry. Specifically, the device 10 can thus be, for example, a processing machine, for example for machining or coating workpieces, or, for example, a conveying device, or a shelving or storage system.

As can be seen from FIG. 1, the production system 100 comprises a (or, optionally, several) detection module 20 which is used to detect at least one measurement parameter with respect to the production system 100. In this respect, the detection module 20 can detect a wide range of measurement parameters and can be designed, for this purpose, for example as a camera, microphone, light sensor, temperature sensor, motion sensor, vibration sensor, tactile sensing device, switch, rocker or various combinations thereof. Other types of detection modules 20 are also possible within the scope of the invention. In any case, the detection module comprises a communication interface 22 which, in the present embodiment, is wireless.

The production system 100 further comprises a multifunctional gateway unit 30 which, in the present embodiment, comprises a substantially cuboid housing 37 and is thus designed as a gateway cube. The components of the multifunctional gateway unit 30 which are illustrated in FIG. 1 are arranged in the housing 37, with the “cube” being designed, in terms of size and weight, such that it can be moved without any problems by an operator and can be deposited at any location. The housing 37 further comprises, although not shown in FIG. 1, mounting aids such as eyelet arrangements, magnet holders or the like, in order to attach the housing 37 to the device 10 or to another suitable location at least temporarily, if necessary.

As shown in FIG. 1, the multifunctional gateway unit 30 comprises a detection interface 32 which is used to connect the gateway unit 30 to a detection module 20 in order to receive data therefrom.

Moreover, the multifunctional gateway unit 30 comprises a computing unit 31 which, in the present embodiment, is designed as a single-board computer, for example of the Raspberry Pi type. The computing unit 31 is used to exchange data with the detection interface 32 and further units and interfaces of the multifunctional gateway unit 30, and to process these data.

Moreover, in the present embodiment, the multifunctional gateway unit 10 comprises two further interfaces, namely two output interfaces 33. Their function is to receive data from the computing unit 31 and to forward said data to an external unit 40 or 42, 50, which are described in more detail below.

In the present embodiment, the communication interface 22 of the detection module and the detection interface 32 and output interface 33 of the multifunctional gateway unit 30 use wireless technology such as, in particular, WLAN, Bluetooth, Zigbee, ZWave, Enocean and Endiio. Thus, secure and simple coupling and data transmission are ensured.

In addition, the detection module 20 and the multifunctional gateway unit 30 communicate with each other via a communication client 24 provided in the detection module 20 and a communication server 34 provided in the multifunctional gateway unit 30. In the present embodiment, these operate on the basis of the communication standard MQTT which allows simple, secure and energy-saving communication. Alternatively, other communication standards such as CoAP, DDS or XNPP are also possible.

In this respect, the MQTT server 34 of the multifunctional gateway unit 30 acts as a so-called “broker” that holds the entire data of its communication partners and can thus be used as a state database. It is therefore possible to connect for example even small MQTT devices that may have low power to the MQTT broker, with the devices (detection modules 20) collecting data and/or receiving commands while a complex overview of the situation is created on the MQTT broker.

The communication server 34 (broker) of the multifunctional gateway unit 30 is designed to check whether the communication standards of the communication server 34 and of the communication client 24 are identical and, if they are identical, to couple the multifunctional gateway unit 30 to the detection module 20 via the communication interfaces 22 and 32. This procedure can in principle be performed without user intervention. Alternatively, it is also possible that the coupling procedure takes place only after selection and/or release by a user or an operator.

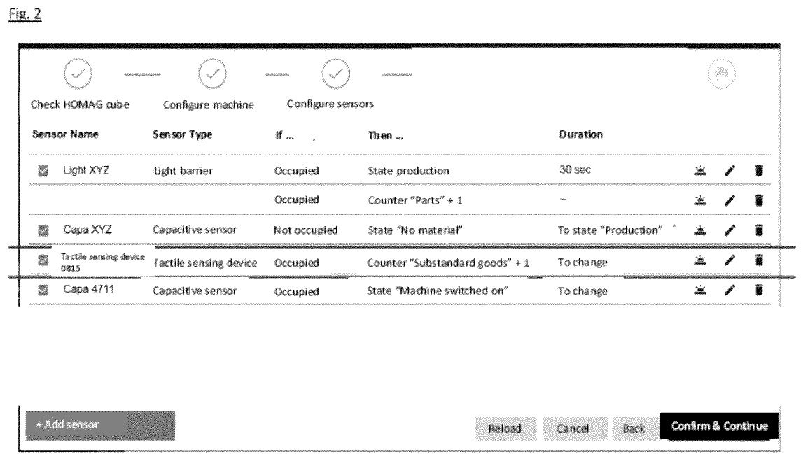

Moreover, the production system comprises a configuration module 35 which, in the present embodiment, is provided in the multifunctional gateway unit 30. The configuration module 35 is used to configure the respective detection module 20 by inputting a condition for a detection result of the detection module 20. On the other hand, an instruction is also input or defined, which is to be output to at least one external unit 40, 42, 50 when the condition is fulfilled.
or this purpose, the configuration module 35 in the present embodiment provides a graphical user interface which is illustrated, by way of example, in FIG. 2. The user interface can be displayed on a screen, for example, or on another display device such as a mobile terminal 50, which is described in more detail below. As can be seen from FIG. 2, various objects can be selected graphically at the graphical user interface, for example the respective detection module (column “Sensor Name”), the type of detection module (column “Sensor Type”), the type of condition (column “If”), the content of the condition (content of the column “If . . . ”) as well as the type, content and color seal parameters of the instruction (columns “Then . . . ” and “Duration”).

What is not explicitly shown in FIG. 2 is a graphical selection of the external unit to be addressed, although this would also be possible. In addition, the graphical user interface can also graphically allow further functions such as editing, deleting, activating etc. When using this graphical user interface, it is not necessary to make any inputs other than graphical inputs and, optionally, parameter value inputs, although this is possible, of course. The configuration of the production system or of the detection module is therefore very simple, quick and intuitive.

Moreover, the production system comprises an output module 36 which, in the present embodiment, is also part of the multifunctional gateway unit 30. The output module 36 is used to monitor the values detected by means of the detection module 20 and, depending on the configuration of the detection module 20, to output an instruction to the external unit 40, 42, 50 defined in the configuration.

As already mentioned above, the production system in the present embodiment comprises three external units, namely, on the one hand, a data server 40 which can be stored locally or provided non-locally (in the “cloud”), a display device 42 which, in the present embodiment, is arranged in the area of the device 10, and a mobile terminal 50 which is discussed in more detail below. It should be noted, however, that within the scope of the invention, various other external units can be addressed and integrated, for example lighting, actuator (such as a cylinder, motor, switchable socket, temperature control, fan or other actuator etc.), loudspeaker etc., which can also be arranged in the area of the device 10 at the location indicated by reference number 42 or at another suitable location. In this respect, an external unit can also be integrated with the detection module 20 fully or in parts. For example, a so-called smart speaker can be used as both the detection module 20 and the external unit 42.

Moreover, the production system 100 in the present embodiment comprises a mobile terminal 50 which can be designed for example in the manner of a smartphone, tablet computer or other portable computer, and which advantageously comprises a touchscreen, a voice input system and/or gesture control. The mobile terminal 50 is designed to communicate with the multifunctional gateway unit 30, with it being possible for this communication to take place for example directly via the output interface 33 of the gateway unit 30, or indirectly via the data server 40. In this respect, it should be noted that, if necessary, it is also possible to switch between the two types of communication, so that, for example, communication takes place via the data server 40 only if data from the data server 40 are required for the current action, while in other cases direct communication takes place between the mobile terminal 50 and the gateway unit 30, for example via a WLAN or Bluetooth connection.

In the present embodiment, the mobile terminal 50 comprises an NFC interface, so that identification and an exchange of basic data, as a basis for the coupling procedure, can already take place before coupling of the mobile terminal 40 to the gateway unit 30. Thus, the mobile terminal 50 can in particular also receive information regarding the current location and the components of the production system 100.

Due to the design according to the invention, the production system 100 according to the present embodiment can perform a wide range of functions using the detection module 20 and the multifunctional gateway unit 30. Examples may include:
Detecting the supply of consumables by means of the detection module 20 and reordering consumables when a certain threshold value is reached.
Monitoring the degree of wear or the operating state by means of the detection module and outputting information regarding maintenance or repair work.
Monitoring individual components such as an air filter in a pneumatic system and outputting information and, optionally, automatically ordering a new air filter.
Monitoring the properties and quality of produced workpieces and outputting information or initiating measures if deviations have been determined.
Monitoring the operating state of the production system and, optionally, controlling the lighting technology or heating technology, for example when the production system stands still or when the production system is to be started soon.
Monitoring operational safety (for example by means of smoke detectors) and directly communicating and initiating emergency measures.

This list can be continued practically arbitrarily and shows that the present invention offers almost unlimited ways of achieving a strong enhancement of functionality by very simple measures. In this respect, it is particularly advantageous that, in the present invention, a suitable detection module can only be coupled to the multifunctional gateway unit 30 and a configuration comprising (at least) one condition and (at least) one instruction can be defined simply. Thus, neither a considerable mounting effort nor a complicated programming procedure is required. On the contrary, it lies entirely in the hands of the operator of the production system to make a wide range of functional enhancements at any time by simple means and using simple procedures.

In this respect, the functional enhancement can be primarily reflected within the production system 100. On the other hand, however, the functional enhancement can also make use of a server 40 that may be located in the “cloud”, thus establishing direct communication with external partners such as suppliers, customers, clients, emergency services and the like.

The method for operating the production system 100 described above is as follows, for example. First of all, an arbitrary detection module 20 is selected, and a data connection between the communication interface 22 and the detection interface 32 of the multifunctional gateway unit 30 is established. This can be done by merely switching on or bringing the detection module 20 and the multifunctional gateway unit closer to each other. Alternatively, it is also possible to establish a cable connection or to perform a specific operation such as pressing a coupling button for a wireless connection.

The communication server 34 of the multifunctional gateway unit 30 then checks whether the communication standards of the communication server 34 and of the communication client 24 are identical, whereupon the multifunctional gateway unit 30 is coupled to the detection module 20 using the communication interfaces 22 and 32.

After this procedure, the detection module 20 just coupled can be selected and configured in the graphical user interface shown in FIG. 2 by selecting the “Add sensor” button. The corresponding communication module then appears as a new line in the graphical user interface in FIG. 2, so that the user can now perform the configuration of the detection module 20, in particular by defining or inputting a condition for a detection result of the detection module 20 and an instruction to be output to at least one external unit 40, 42, 50 when the condition is fulfilled.

The detection module 20 is now ready for operation and performs the function defined in the configuration.

These statements show once again that the present invention creates a particularly simple and intuitive way of expanding the functional scope of a production system at any time and with maximum flexibility.

1. A production system, comprising:
a device for processing, handling or storing workpieces comprising wood, wood materials or plastic, or for handling or storing mounting material, equipment or tools;
a detection module for detecting at least one measurement parameter, the detection module comprising a wireless communication interface; and
a multifunctional gateway unit comprising:
at least one computing unit which comprises a CPU and is configured to process data detected by the detection module,
at least one wireless detection interface configured to receive data from the detection module and to forward said data to the computing unit, and
at least one wireless output interface configured to receive data from the computing unit and to forward said data to at least one external unit,
wherein the detection module comprises a communication client which operates in accordance with a predetermined communication standard; and
wherein the multifunctional gateway unit comprises a communication server which operates in accordance with the predetermined communication standard and is configured to check whether the communication standards of the communication server and of the communication client are identical and, if they are identical, to couple the multifunctional gateway unit to the detection module via the communication interfaces.

2. The production system according to claim 1, wherein at least one communication standard is selected from MQTT, CoAP, DDS, XMPP and OPC-UA.

3. The production system according to claim 1, wherein at least one wireless interface is selected from WLAN, Bluetooth, Zigbee, ZWave, Enocean and Endiio.

4. The production system according to claim 1, comprising a configuration module which is designed to allow the input of a condition for a detection result of the detection module and the input of an instruction to be output to at least one external unit when the condition is fulfilled.

5. The production system according to claim 4, wherein the configuration module provides a graphical user interface where at least one object selected from the detection module, the type of condition, the content of the condition, the type of instruction, the content of the instruction, and the external unit can be selected graphically.

6. The production system according to claim 4, wherein the configuration module allows the configuration of a detection module by graphical input or input of parameter values without requiring further inputs.

7. The production system according to claim 1, comprising an output module which is configured to monitor the values detected by the detection module and, depending on the configuration of the detection module, to output an instruction to the external unit defined in the configuration.

8. The production system according to claim 1, wherein at least one detection module is selected from a camera, a microphone, a light sensor, a temperature sensor, a motion sensor, a vibration sensor, a tactile sensing device, a switch, a rocker, or combinations thereof.

9. The production system according to claim 1, wherein at least one external unit is selected from a local or non-local data server, a mobile terminal, a display device, lighting, a speaker, an actuator, or combinations thereof.

10. The production system according to claim 1, wherein at least one detection module and at least one external unit are at least partially integrated.

11. The production system according to claim 1, further comprising:
a mobile terminal configured to communicate with the multifunctional gateway unit with the configuration module the output module.

12. A method for operating a production system according to claim 1, comprising the steps of:
establishing a data connection between the communication interface of the detection module and the detection interface of the multifunctional gateway unit;
checking whether communication standards of the communication server of the multifunctional gateway unit and of the communication client of the detection module are identical; and
if the communication standards of the communication server of the multifunctional gateway unit and of the communication client of the detection module are identical, coupling the multifunctional gateway unit to the detection module via the communication interfaces.

13. The method according to claim 12, wherein after coupling the detection module is configured via the configuration module by inputting a condition for a detection result of the detection module and an instruction to be output to at least one external unit when the condition is fulfilled.

14. The method according to claim 13, wherein the input is provided via a graphical user interface where at least one object selected from the detection module, the type of condition, the content of the condition, the type of instruction, the content of the instruction, or the external unit.

15. The method according to claim 13, wherein the configuration of the detection module is performed by graphical input or input of parameter values without requiring further inputs.
